(19) United States
(12) Patent Application Publication
(10) Pub. No.: US 2013/0047619 A1
(43) Pub. Date: Feb. 28, 2013

(54) INJECTION NOZZLE ASSEMBLY FOR A GAS TURBOMACHINE

(71) Applicants: Gregory Allen Boardman, Greer, SC (US); Kwanwoo Kim, Mason, OH (US); Nishant Govindbhai Parsania, Bangalore (IN)

(72) Inventors: Gregory Allen Boardman, Greer, SC (US); Kwanwoo Kim, Mason, OH (US); Nishant Govindbhai Parsania, Bangalore (IN)

(73) Assignee: GENERAL ELECTRIC COMPANY, Schenectady, NY (US)

(21) Appl. No.: 13/221,027

(22) Filed: Aug. 30, 2011

(51) Int. Cl. F23R 3/28; F02D 1/00

(52) U.S. Cl. 60/748; 239/533.2; 239/1

(57) ABSTRACT

An injection nozzle assembly includes a nozzle body having an outer surface and an inner surface that defines a flow passage, and a center body arranged within the nozzle body and extending along the flow passage. The center body includes a first end that extends to a tip portion through an intermediate portion that defines a fluid passage. The intermediate portion includes a first outer dimension and the tip portion includes a second outer dimension that is distinct from the first outer dimension. The center body includes a plurality of grooves that extend axially along the tip portion.

### BACKGROUND OF THE INVENTION

The subject matter disclosed herein relates to the art of turbomachines and, more particularly, to an injection nozzle assembly for a gas turbomachine.

In general, gas turbomachines combust a fuel/air mixture that releases heat energy to form a high temperature gas stream. The high temperature gas stream is channeled to a turbine portion via a hot gas path. The turbine portion converts thermal energy from the high temperature gas stream to mechanical energy that rotates a turbine shaft. The turbine portion may be used in a variety of applications, such as for providing power to a pump or an electrical generator.

Many turbomachines employ premixed injection nozzles that direct a combustible mixture into a combustion chamber. In some cases, the premixed injection nozzles include a center body that injects a portion of the combustible mixture toward a combustion zone of the combustion chamber. Another portion of the combustible mixture flows over and around the center body toward the combustion zone. The portion of the combustible mixture flowing over the center body often times creates ring vortices that propagate toward the combustion zone. The ring vortices can lead to flame instability in the combustion chamber as well as creating undesirable combustion dynamics that impact turbomachine efficiency.

### BRIEF DESCRIPTION OF THE INVENTION

According to one aspect of the exemplary embodiment, an injection nozzle assembly includes a nozzle body having an outer surface and an inner surface that defines a flow passage, and a center body arranged within the nozzle body and extending along the flow passage. The center body includes a first end that extends to a tip portion through an intermediate portion that defines a fluid passage. The intermediate portion includes a first outer dimension and the tip portion includes a second outer dimension that is distinct from the first outer dimension. The center body includes a plurality of grooves that extend axially along the tip portion.

According to another aspect of the exemplary embodiment, a turbomachine includes a compressor portion, a turbine portion operatively coupled to the compressor portion, and a combustor portion fluidly connecting the compressor portion and the turbine portion. The combustor portion includes an injection nozzle assembly having a nozzle body including an outer surface and an inner surface that defines a flow passage, and a center body arranged within the nozzle body and extending along the flow passage. The center body includes a first end that extends to a tip portion through an intermediate portion that defines a fluid passage. The intermediate portion includes a first outer dimension and the tip portion includes a second outer dimension that is distinct from the first outer dimension. The center body includes a plurality of grooves that extend axially along the tip portion.

According to yet another aspect of the exemplary embodiment, a method of mixing a first fluid and a second fluid passing from an injection nozzle into a turbomachine combustion chamber includes passing the first fluid through a center body of the injection nozzle, passing the second fluid over the center body , channeling the second fluid into a plurality of grooves formed in a tip portion of the center body , inducing longitudinal mixing vortices into the second fluid, and discharging the first fluid from the tip portion of the center body , the longitudinal mixing vortices enhancing mixing of the first and second fluids to form a combustible mixture.

These and other advantages and features will become more apparent from the following description taken in conjunction with the drawings.

### BRIEF DESCRIPTION OF THE DRAWINGS

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 is a schematic-sectional view of a gas turbomachine including an injection nozzle assembly in accordance with an exemplary embodiment;

FIG. 2 is a partial cross-sectional perspective view of an injection nozzle assembly in accordance with an exemplary embodiment;

FIG. 3 is a plan view of the injection nozzle assembly of FIG. 2; and

FIG. 4 is a detail view of a tip portion of the injection nozzle assembly of FIG. 2.

The detailed description explains embodiments of the invention, together with advantages and features, by way of example with reference to the drawings.

### DETAILED DESCRIPTION OF THE INVENTION

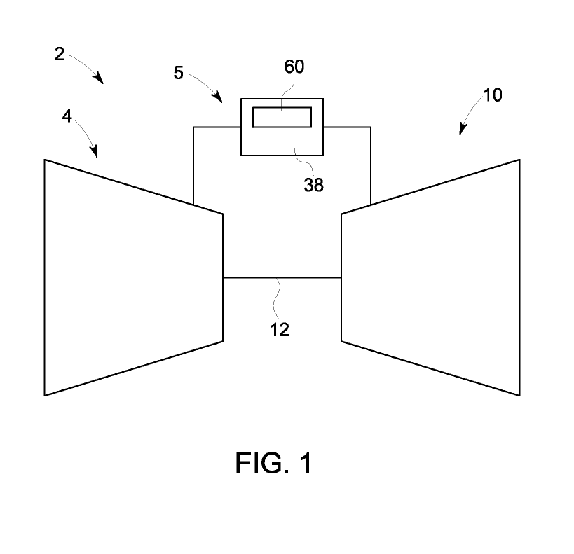

With initial reference to FIG. 1, a turbomachine constructed in accordance with an exemplary embodiment is indicated generally at 2. Turbomachine 2 includes a compressor portion 4 fluidly connected to a combustor assembly 5. Turbomachine 2 also includes a turbine portion 10 operatively connected to compressor portion 4 through a common compressor/turbine shaft 12. Combustor assembly 5 includes a combustion chamber 38 and is coupled in flow communication with compressor portion 4 and turbine portion 10. With this arrangement, compressed air is passed into combustor assembly 5, mixed with fuel, and combusted to form hot gases. The hot gases are channeled to turbine portion 10 which converts thermal energy from the hot gases into mechanical rotational energy. The above described structure has been provided for the sake of completeness, and to enable a better understanding of the exemplary embodiments which are directed to an injection nozzle assembly 60 arranged within combustor assembly 5.

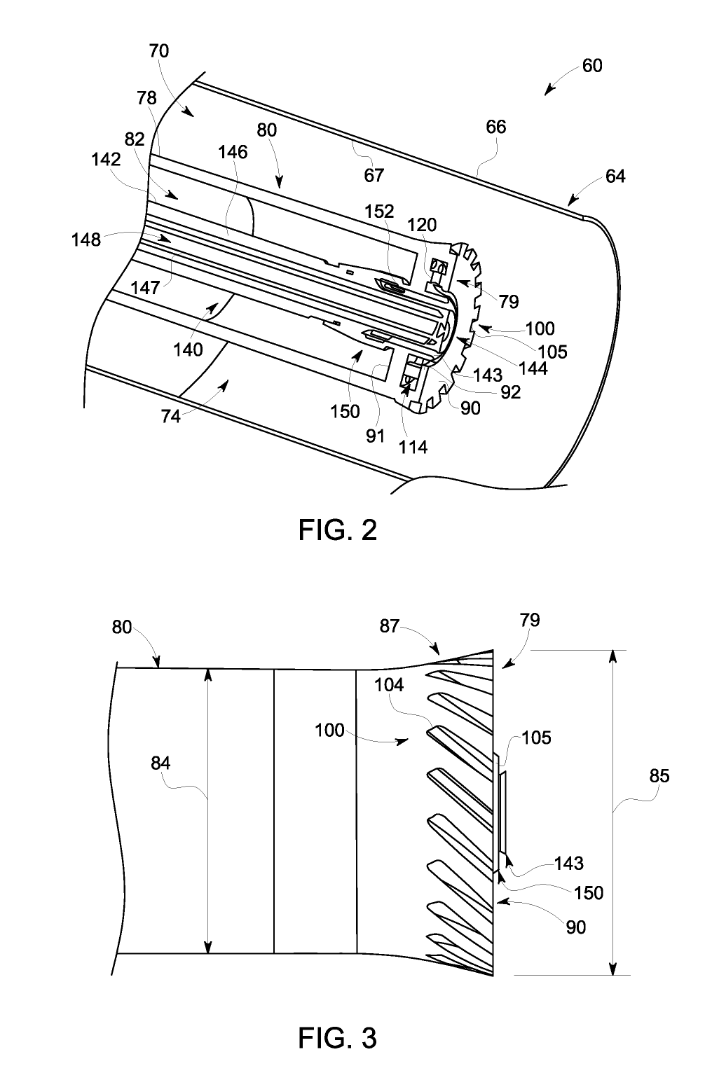

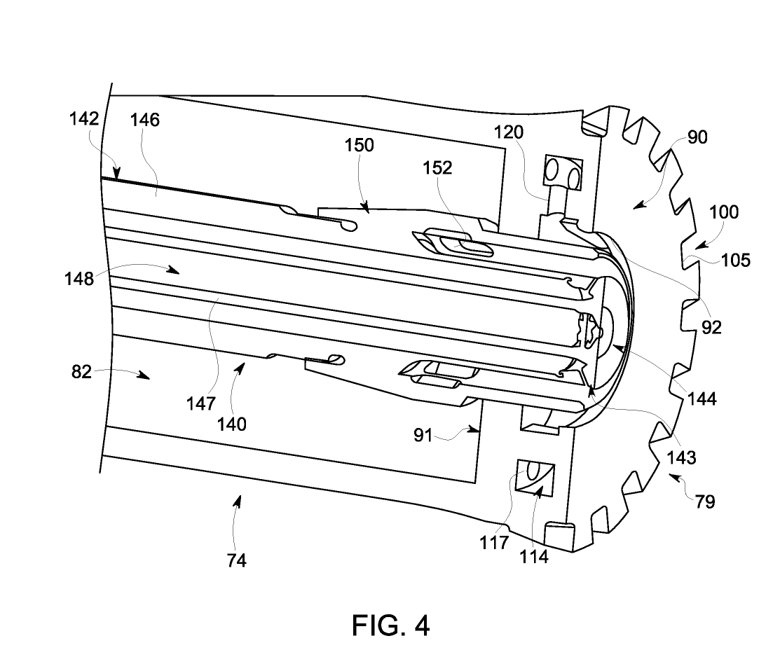

As best shown in FIGS. 2-4, injection nozzle assembly 60 includes a nozzle body 64 having an outer surface 66 and an inner surface 67 that defines a flow passage 70. Injection nozzle assembly 60 is also shown to include a center body 74 that extends within flow passage 70. Center body 74 includes a first end 78 that extends to a second end or tip portion 79 through an intermediate portion 80 that defines a fluid passage 82. In accordance with the exemplary embodiment shown, intermediate portion 80 includes a circular cross-section having a first outer dimension 84 and tip portion 79 includes a circular cross-section having a second outer dimension 85. First outer dimension 84 defines a first diameter and second outer dimension 85 defines a second diameter. Second outer dimension 85 is greater than first outer dimension 84 so as to define a flared region 87 at tip portion 79.

In further accordance with the exemplary embodiment, tip portion 79 includes an outer face 90 and an inner face 91. Outer face 90 includes an outlet 92 which, as will be discussed more fully below, discharges first and second fluids, generally fuel and air, into combustion chamber 38. Tip portion 79 also includes a plurality of grooves, one of which is indicated at 100. Grooves 100 extend annularly about tip portion 79 and include a first end portion 104 that extend to a second end portion 105 that is exposed at outer face 90. In the exemplary embodiment shown, second end portion 105 is off-set from first end portion 104. In this manner, a swirl imparted to fluid flow passing through an upstream swozzle (not shown) is channeled through grooves 100 toward combustion chamber 38. By off-setting second end portion 105 from first end portion 104, disturbances in the swirl are avoided. In the event that injection nozzle assembly 60 is not provided with a swozzle, first end portion 104 may be formed so as to be in-line with second end portion 105.

Center body 74 is also includes an annular fluid plenum 114 arranged in tip portion 79 between outer face 90 and inner face 91. Annular fluid plenum 114 includes a plurality of inlet openings, one of which is indicated at 117, that lead to fluid passage 82 and a plurality of discharge openings 120 that lead to outlet 92. In this manner, fluid, such as air, passing through fluid passage 82 is directed toward inner face 91. A first portion of the fluid provides cooling to inner face 91 while a second portion of the fluid passes into annular fluid plenum 114. The second portion of fluid flows about annular fluid plenum 114 and passes through discharge openings 120 toward outlet 92. The second portion of fluid aids in fuel atomization as will be discussed more fully below.

Center body 74 is further shown to include a fluid cartridge 140 that passes through fluid passage 82. Fluid cartridge 140 includes a first end section 142 that extends to a second end section 143. Second end section 143 is provided with an outlet section 144. First end section 142 is arranged at first end 78 while second end section 143 passes through outlet 92 with outlet section 144 extending proud relative to, or beyond outer face 90. Fluid cartridge 140 includes an outer body 146 and an inner body 147 that defines a fluid channel 148. Fluid cartridge 140 further includes a shroud 150 positioned at second end section 143. Shroud 150 includes a plurality of passages, one of which is indicated at 152, that channel fluid from fluid passage 82 toward outlet section 144. The fluid not only provides cooling to second end section 143 but also contributes to atomization of fluid, such as fuel, passing through fluid cartridge 140 toward combustion chamber 38.

In accordance with the exemplary embodiments, fluid passing from fluid passage 82 through shroud 150 and annular fluid plenum 114 contributes to atomizing fuel passing from fluid cartridge 140 to enhance combustion. In addition, fluid, such as air, passing over center body 74 enters into grooves 100 and flows toward combustion chamber 38. The fluid passing through grooves 100 reduces combustion dynamics by breaking up large scale vortex rings that may be generated in combustion chamber 38 as well as improves flame stability and enhances turndown by generating longitudinal mixing vortices that increase hot product, and fresh reactant mixing intensity. At this point it should be understood that the number and pitch of the grooves can vary depending upon nozzle geometry and nozzle components. In addition, while the grooves and annular fluid plenum are shown augmenting a fluid cartridge, other fluid and/or fuel introduction systems could also be employed. The particular type of fuel can vary and fuel may include homogeneous fuels, mixtures of fuel, mixtures of fuel and diluents, as well as mixtures of fuel and other constituents.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. An injection nozzle assembly comprising:
a nozzle body including an outer surface and an inner surface that defines a flow passage; and
a center body arranged within the nozzle body and extending along the flow passage, the center body including a first end that extends to a tip portion through an intermediate portion that defines a fluid passage, the intermediate portion including a first outer dimension and the tip portion including a second outer dimension that is distinct from the first outer dimension, the center body including a plurality of grooves that extend axially along the tip portion.

2. The injection nozzle assembly according to claim 1, wherein the tip portion includes an outer face, each of the plurality of grooves including a first end portion that extends to a second end portion, the second end portion being exposed at the outer face.

3. The injection nozzle assembly according to claim 2, wherein the first end portion is off-set relative to the second end portion.

4. The injection nozzle assembly according to claim 1, wherein the center body includes a circular cross-section, the first outer dimension defining a first diameter and the second outer dimension defining a second diameter.

5. The injection nozzle assembly according to claim 4, wherein the second diameter is larger than the first diameter thereby forming a flared region.

6. The injection nozzle assembly according to claim 2, wherein the tip portion includes an annular fluid plenum fluidly connected to the fluid passage and an outlet formed in the outer face, the outlet being fluidly connected to the annular fluid plenum.

7. The injection nozzle assembly according to claim 6, wherein the center body includes a fluid cartridge extending through the fluid passage to the outlet, the fluid cartridge including an outlet section that is exposed to the flow passage.

8. The injection nozzle assembly according to claim 7, wherein the outlet section extends beyond the outer face.

9. A turbomachine comprising:
a compressor portion;
a turbine portion operatively coupled to the compressor portion; and
a combustor portion fluidly connecting the compressor portion and the turbine portion, the combustor portion including an injection nozzle assembly comprising:
a nozzle body including an outer surface and an inner surface that defines a flow passage; and
a center body arranged within the nozzle body and extending along the flow passage, the center body including a first end that extends to a tip portion through an intermediate portion that defines a fluid passage, the intermediate portion including a first outer dimension and the tip portion including a second outer dimension that is distinct from the first outer dimension, the center body including a plurality of grooves that extend axially along the tip portion.

10. The turbomachine according to claim 9, wherein the tip portion includes an outer face, each of the plurality of grooves including a first end portion that extends to a second end portion, the second end portion being exposed at the outer face.

11. The turbomachine according to claim 10, wherein the first end portion is off-set relative to the second end portion.

12. The turbomachine according to claim 9, wherein the center body includes a circular cross-section, the first outer dimension defining a first diameter and the second outer dimension defining a second diameter.

13. The turbomachine according to claim 12, wherein the second diameter is larger than the first diameter thereby forming a flared region.

14. The turbomachine according to claim 10, wherein the tip portion includes an annular fluid plenum fluidly connected to the fluid passage and an outlet formed in the outer face, the outlet being fluidly connected to the annular fluid plenum.

15. The turbomachine according to claim 14, wherein the center body includes a fluid cartridge extending through the fluid passage to the outlet, the fluid cartridge including an outlet section that is exposed to the flow passage.

16. The turbomachine according to claim 15, wherein the outlet section extends beyond the outer face.

17. A method of mixing a first fluid and a second fluid passing from an injection nozzle into a turbomachine combustion chamber, the method comprising:
passing the first fluid through a center body of the injection nozzle;
passing the second fluid over the center body;
channeling the second fluid into a plurality of grooves formed in a tip portion of the center body;
inducing longitudinal mixing vortices into the second fluid; and
discharging the first fluid from the tip portion of the center body, the longitudinal mixing vortices enhancing mixing of the first and second fluids to form a combustible mixture.

18. The method of claim 17, further comprising: passing a third fluid across a fluid cartridge onto an inner surface of the tip portion.

19. The method of claim 18, further comprising: guiding a portion of the third fluid into an annular fluid plenum extending within the tip portion.

20. The method of claim 19, further comprising: discharging the portion of the third fluid from the annular fluid plenum toward an outlet formed in the tip portion.
